(19) United States
(12) Patent Application Publication
(10) Pub. No.: US 2010/0315986 A1
(43) Pub. Date: Dec. 16, 2010

(54) WIRELESS BROADCAST COMMUNICATION SYSTEM AND BROADCAST SERVICE METHOD THEREOF

(75) Inventors: Il Ho Lee, Hwaseong-si (KR); Yeon Ju Lim, Seoul (KR); Hong Sil Jeong, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/813,176

(22) Filed: Jun. 10, 2010

(30) Foreign Application Priority Data
Jun. 10, 2009 (KR) 10-2009-0051653

(51) Int. Cl. H04W 40/00

(52) U.S. Cl. 370/312

(57) ABSTRACT

A wireless broadcast communication system includes a transmitter that provides broadcast services via a plurality of frames based on inband signaling, and a receiver that switches a sleep mode to an active mode and receives the target broadcast packets, according to the timing information. The receiver is repeatedly switched to the sleep mode according to the timing information. The system uses the scheduling information to detect broadcast packets via a plurality of frames, thereby enhancing the use efficiency of the scheduling information. Although the receiver fails to receive scheduling information via a particular frame, it can detect a position of a broadcast packet using the stored scheduling information.

### PRIORITY

This application claims priority under 35 U.S.C. §119(a) to an application filed in the Korean Intellectual Property Office on Jun. 10, 2009 and assigned Serial No. 10-2009-0051653, the contents of which are incorporated herein by reference.

### BACKGROUND OF THE INVENTION

1. Field of the Invention

The present invention relates generally to communication systems, and more particularly, to a wireless broadcast communication system and a broadcast service method thereof that can provide broadcast services via a plurality of successive frames.

2. Description of the Related Art

Broadcast services generally provide digitalization, various channels, broadband, and high quality. Recently, as such devices as high definition televisions, Portable Multimedia Players (PMPs), and portable broadcast devices have proliferated, wireless broadcast communication systems have been increasingly researched and developed to provide broadcast services via various modes.

In a Digital Video Broadcasting-second generation Terrestrial (DTB-T2) system, a standard for providing broadcast services has been proposed to fixed or mobile receivers. A Digital Video Broadcasting-Next Generation Handheld (DVB-NGH) system has also been developed as a standard for mobile receivers employing a mobile communication technology. The DVB-NGH system is being standardized based on the physical architecture of the DVB-T2, which differs from a Digital Video Broadcasting-Handheld (DVB-H) system serving as the first generation mobile broadcast standard. Like the DVB-T2 system, the DVB-NGH system can support various channel environments and various system parameter modes, and also guarantee the mobility of receivers, to which the power consumption of receivers is an important factor.

Wireless broadcast communication systems provide broadcast services of various broadcast channels via a plurality of successive frames. Each frame is transmitted, containing broadcast packets by broadcast channels and a control signal for a transmission manner of the broadcast packets. That is, wireless broadcast communication systems transmit broadcast packets at each frame via a plurality of data channels and a control signal via a control channel. Wireless broadcast communication systems may not transmit broadcast packets at each frame with respect to the identical broadcast channel, due to the power consumption of receivers.

Wireless broadcast communication systems may insert part of a control signal, as inband signaling, into a data channel and then transmit the control signal. That is, wireless broadcast communication systems may insert scheduling information regarding variable broadcast packets into broadcast packets according to frames and transmit the scheduling information, which is used to detect a position of a particular broadcast packet from another frame following the present frame. That is, a receiver can switch the current mode to an active mode based on the scheduling information and then receive broadcast packets, after which the receiver may switch the active mode to a sleep mode. The receiver can reduce the power consumption by switching between the active and sleep modes.

However, conventional wireless broadcast communication systems are disadvantageous in that they cannot efficiently use scheduling information, since it is used only to detect a particular broadcast packet in a single frame. That is, if a receiver does not receive scheduling information, it needs to maintain an active mode until it receives a corresponding broadcast packet, without being switched to a sleep mode, as shown in FIG. 1. This is because the receiver cannot detect the position of a corresponding broadcast packet without scheduling information. Therefore, if the receiver moves to a reception failure area, it cannot receive scheduling information transmitted by the transmitter, so that it must maintain an active mode.

### SUMMARY OF THE INVENTION

The present invention has been made in view of the above problems, and provides a wireless broadcast communication system and a broadcast service method thereof that can provide broadcast services via a plurality of successive frames.

In accordance with an embodiment of the present invention, provided is a broadcast service method of a transmitter in a wireless communication system, including inserting scheduling information, as inband signaling, into a serving broadcast packet, and transmitting the scheduling information via one of a plurality of frames, wherein the scheduling information includes timing information regarding next target broadcast packets, and transmitting the target broadcast packets according to the timing information.

In accordance with another embodiment of the present invention, provided is a broadcast service method of a receiver in a wireless communication system, including receiving scheduling information via a serving broadcast packet from one of a plurality of frames, wherein the scheduling information, as inband signaling, is inserted into the serving broadcast packet, and includes timing information regarding next target broadcast packets, and receiving the target broadcast packets according to the timing information.

In accordance with another embodiment of the present invention, provided is a transmitter of a wireless communication system, including a broadcast packet configuring unit and a frame transmitting unit. The broadcast packet configuring unit inserts scheduling information, as inband signaling, into a serving broadcast packet. The scheduling information includes timing information regarding next target broadcast packets. The frame-transmitting unit transmits the serving broadcast packet via one from among a plurality of frames. The frame-transmitting unit also transmits target broadcast packets according to the timing information.

In accordance with another embodiment of the present invention, provided is a receiver in a wireless communication system, including a frame receiving unit, a scheduling information analyzing unit, and a frame selecting unit. The frame-receiving unit receives a serving broadcast packet via one of a plurality of frames, and next target broadcast packets. The scheduling information-analyzing unit analyzes scheduling information including timing information of the target broadcast packets when the serving broadcast packet is received. The scheduling information, as inband signaling, is inserted into the serving broadcast packet. The frame-selecting unit performs a control operation to receive the target broadcast packets according to the timing information.

### BRIEF DESCRIPTION OF THE DRAWINGS

The features and advantages of the present invention will become more apparent from the following detailed description in conjunction with the accompanying drawings, in which:

FIG. 1 illustrates a method for receiving broadcast packets in a conventional wireless broadcast communication system;

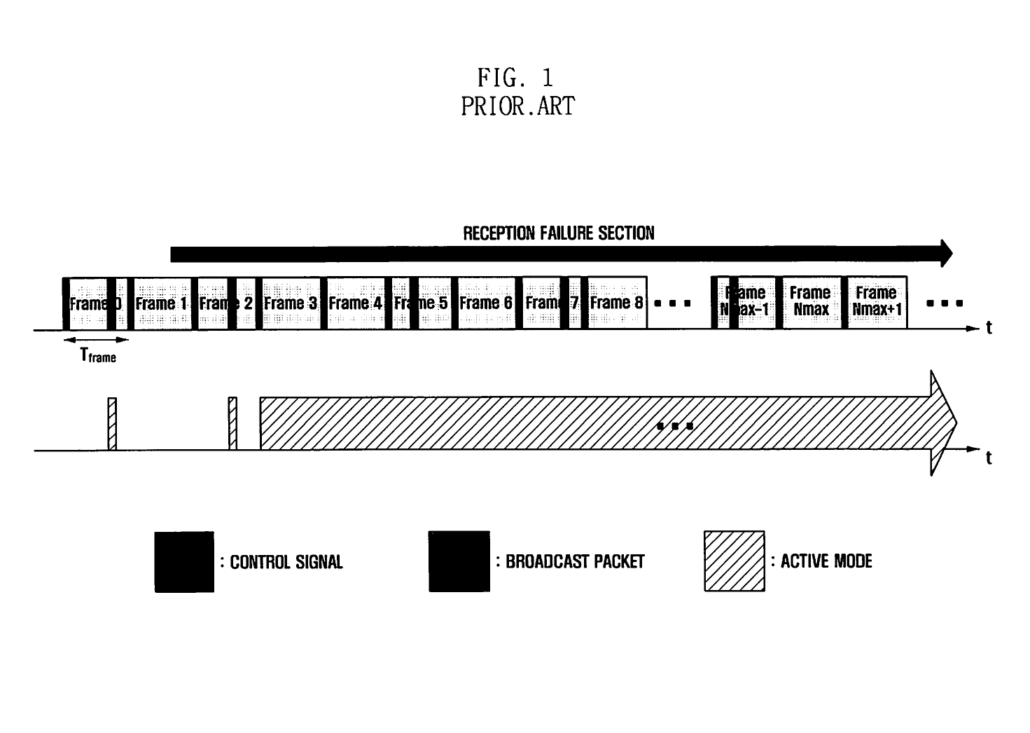

FIG. 2 illustrates a configuration of a wireless broadcast communication system according to an embodiment of the present invention;

FIG. 3 illustrates a structure of a super frame in a wireless broadcast communication system according to an embodiment of the present invention;

FIGS. 4a and 4b illustrate a method for transmitting broadcast packets in a wireless broadcast communication system according to an embodiment of the present invention;

FIGS. 5a and 5b illustrates a method for receiving broadcast packets in a wireless broadcast communication system according to an embodiment of the present invention;

FIG. 6 illustrates a transmitter of a wireless broadcast communication system according to an embodiment of the present invention;

FIG. 7 illustrates a method for transmitting broadcast packets from a transmitter of a wireless broadcast communication system according to an embodiment of the present invention;

FIG. 8 illustrates a receiver of a wireless broadcast communication system according to an embodiment of the present invention;

FIG. 9 illustrates a method for receiving broadcast packets from a transmitter of a wireless broadcast communication system according to an embodiment of the present invention;

FIG. 10 illustrates a method of configuring a time table shown in FIG. 9;

FIG. 11 illustrates a method of altering a time table shown in FIG. 9; and

FIG. 12 illustrates a method of reconfiguring a time table shown in FIG. 9.

### DETAILED DESCRIPTION OF EMBODIMENTS OF THE INVENTION

Hereinafter, embodiments of the present invention are described in detail with reference to the accompanying drawings. The same reference numbers are used throughout the drawings to refer to the same or similar parts. Detailed descriptions of well-known functions and structures incorporated herein may be omitted for the sake of clarity and conciseness.

The following terms used in the present description and the claims should not be limited by a general or lexical meaning, but instead should be analyzed as a meaning and a concept through which the inventor defines and describes the present invention. Therefore, one skilled in the art will understand that the embodiments disclosed in the description and configurations illustrated in the drawings are not exhaustive, and there may be various modifications, alterations, and equivalents thereof in addition to the embodiments at the time of filing this application.

A ‘serving frame’ refers to a frame that provides a current broadcast service in a wireless broadcast communication system. A ‘serving broadcast packet’ refers to data that is provided by the serving frame via a particular broadcast channel. A ‘target frame’ refers to another frame successive to the serving frame in a wireless broadcast communication system. That is, the target frame provides a broadcast service via the same broadcast channel as the serving frame that provides the serving broadcast packet. A ‘target broadcast packet’ refers to data that the target frame provides via the same broadcast channel as the serving frame that provides the serving broadcast packet.

‘Scheduling information’ refers to information presenting a position of a target broadcast packet via at least one target frame in a wireless broadcast communication system. The scheduling information, as inband signaling, is inserted into the serving broadcast packet in a serving frame. ‘Timing information’ refers to information presenting a position of a target broadcast packet in each target frame. Scheduling information contains timing information according to target broadcast packets.

An ‘active mode’ refers to a state where all the elements included in the receiver are operated. During the active mode, the receiver operates at full power. A ‘sleep mode’ refers to a state in which a portion of the elements included in the receiver are operated. For example, during the sleep mode, the receiver operates a portion of the elements required to switch the current mode to an active mode, i.e., the receiver operates a portion of the elements with least power, and breaks power to the remaining elements.

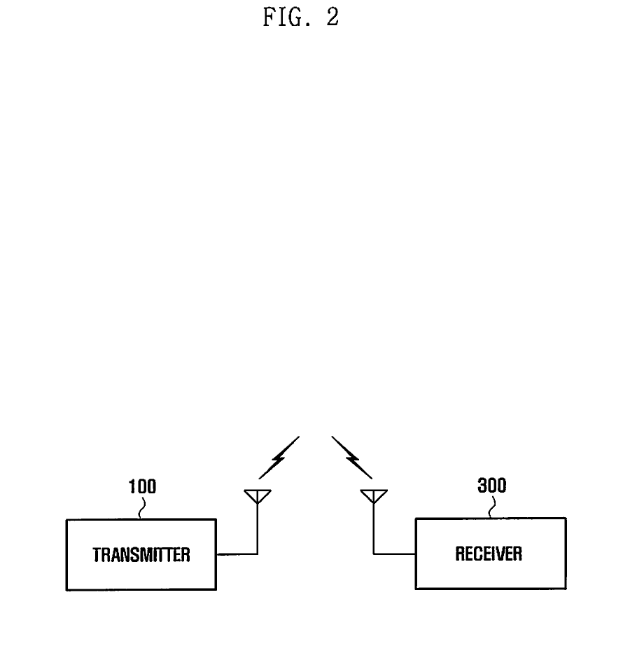

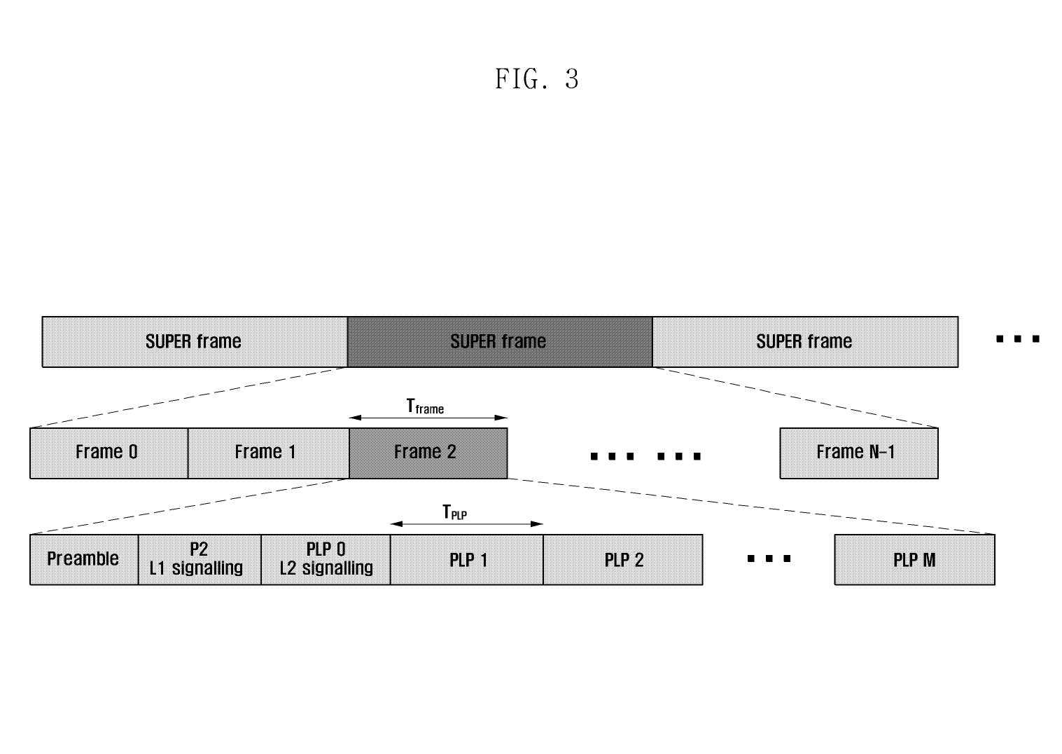

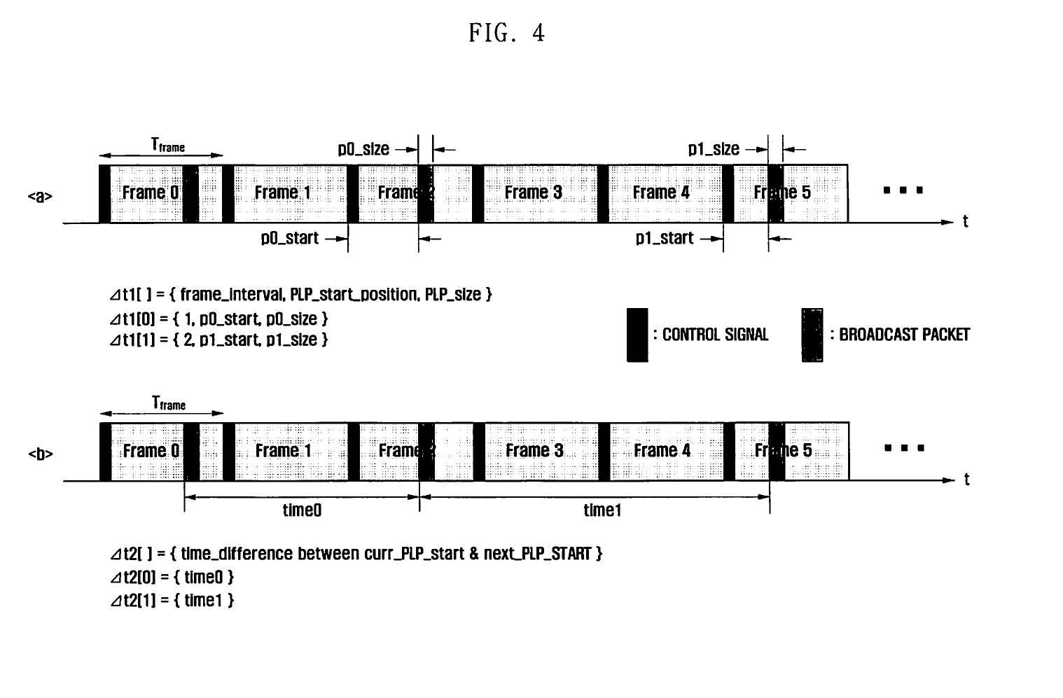

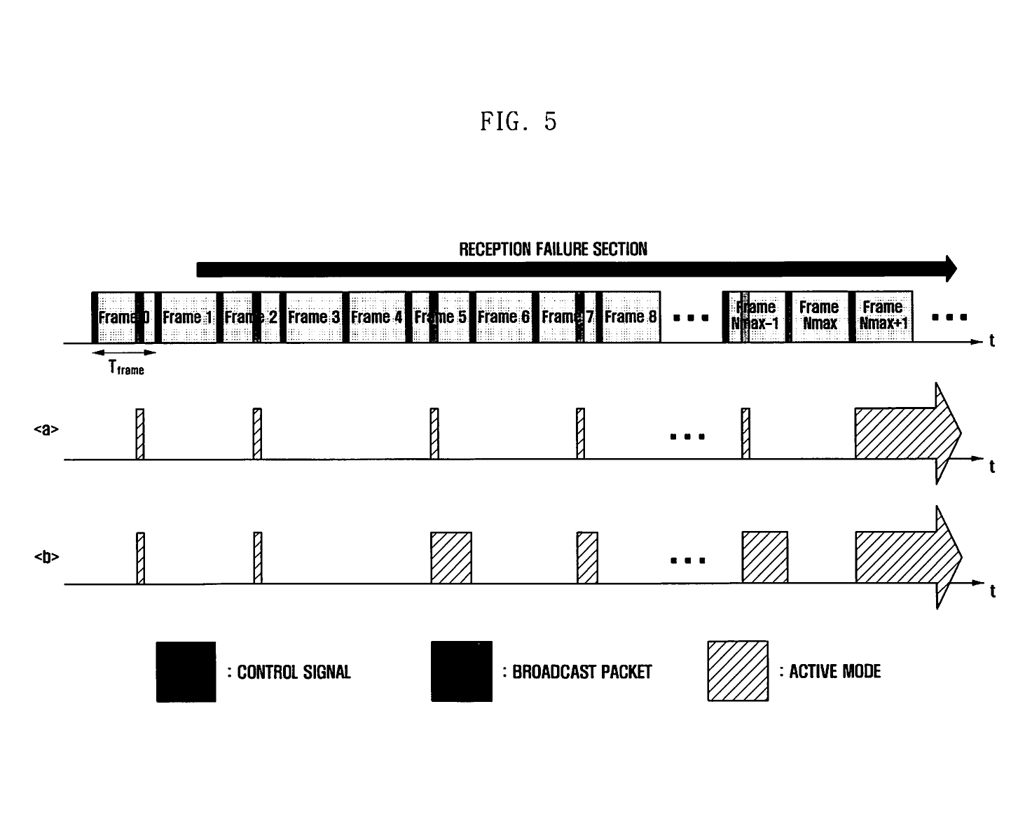

FIG. 2 illustrates a configuration of a wireless broadcast communication system according to an embodiment of the present invention. FIG. 3 illustrates a structure of a super frame in a wireless broadcast communication system according to an embodiment of the present invention. FIGS. 4a and 4b illustrate a method for transmitting broadcast packets in a wireless broadcast communication system according to an embodiment of the present invention. FIGS. 5a and 5b illustrate a method for receiving broadcast packets in a wireless broadcast communication system according to an embodiment of the present invention.

Referring to FIG. 2, the wireless broadcast communication system includes a transmitter 100 and a receiver 300.

The transmitter 100 transmits a control signal and broadcast packets via each frame. That is, as shown in FIG. 3, the transmitter 100 provides a broadcast service based on the structure of successive super frames, each of which including successive N frames having a frame size T_{frame}. Each frame is comprised of a control channel and a data channel. A data channel is comprised of M sub channels, i.e., Physical Layer Pipe (PLP). Each sub channel has a sub-size T_{PLP}. The transmitter 100 transmits a control signal via a control channel and broadcast packets via a data channel.

The control signal s comprised of a preamble, L1 signaling (P2), and L2 signaling (PLP0). The transmitter 100 sequentially transmits the preamble, L1 signaling and L2 signaling via the control channel. The preamble serves as a signal to perform time and frequency synchronization via a corresponding frame. L1 signaling is a physical layer signal and contains a static field, a configuration field, and a dynamic field. The static field represents such parameters as a cell identifier, a network identifier, the number of wireless channels, and the frame size. The configuration field presents such information as a broadcast service identifier, a coding rate and a modulation of service traffic for a broadcast service. The dynamic field represents a position of a broadcast packet at a current frame. In an embodiment of the present invention, the dynamic field may contain scheduling information. L2 signaling is a Medium Access Control (MAC) layer signal and contains information linking a sub channel and a broadcast channel that provides a particular broadcast packet.

The transmitter 100 also transmits broadcast packets of other broadcast channels via sub channels, respectively. As shown in FIGS. 4a and 4b, the transmitter 100 inserts scheduling information, as inband signaling, into broadcast packets and then transmits the scheduling information. The transmitter 100 configures scheduling information according to broadcast channels and then inserts the scheduling information to broadcast packets of a corresponding broadcast channel. That is, the transmitter 100 can insert scheduling information, comprising timing information according to target broadcast packets, into serving broadcast packets at a serving frame.

As shown in FIG. 4a, the timing information may contain a frame interval, frame_interval, between a serving frame and a target frame or between target frames, a target broadcast packet start position, PLP_start_position, at a target frame, and a target broadcast packet size, PLP_size. For example, at a serving frame having a frame index of zero, the timing information of the first target broadcast packet at the first target frame closest to the serving frame may be ‘Δt1[0]={1, p0_start, p0_size}’. In addition, the timing information of the second target broadcast packet at the second target frame closest to the first target frame may be ‘Δt1[1]={2, p1_start, p1_size}’. That is, the transmitter 100 can insert scheduling information having ‘Δt1[0]’ and ‘Δt1[1]’ in the serving broadcast packet.

A shown in FIG. 4B, the timing information may be a start time difference between a serving broadcast packet and a target broadcast packet or between target broadcast packets, time_difference between curr_PLP_start & next_PLP_start. For example, at a serving frame having a frame index of zero, the timing information of the first target broadcast packet at the first target frame closest to the serving frame may be ‘Δt2[0]={time0}’. In addition, the timing information of the second target broadcast packet at the second target frame closest to the first target frame may be ‘Δt2[1]={time1}’. That is, the transmitter 100 can insert scheduling information having ‘Δt2[0]’ and ‘Δt2[1]’ in the serving broadcast packet.

The receiver 300 receives a control signal or at least one broadcast packet at a particular frame using a broadcast service use mode. That is, as shown in FIG. 3, the receiver 300 uses a broadcast service based on the structure of successive super frames. The receiver 300 is connected to the transmitter 100 in order to be operated in a broadcast service user mode. The receiver 300 analyzes a control signal in order to be connected to the transmitter 100. The receiver 300 then selects a broadcast packet of a particular sub channel from the data channels and then receives the broadcast packet. As shown in FIGS. 5a and 5b, the receiver 300 switches the current mode to an active mode at a corresponding sub channel and then receives the broadcast packet, after which the receiver 300 switches the active mode to a sleep mode.

The receiver 300 performs the mode switching between the active mode and the sleep mode, based on scheduling information. That is, receiver 300 receives a serving broadcast packet at a serving frame, analyzes scheduling information of the serving broadcast packet and detects timing information regarding a target broadcast packet. According to the timing information, the receiver 300 receives target broadcast packets via the target frame. That is, the receiver 300 does not need to receive a control signal via the target frame.

For example, as shown in FIG. 5a, the receiver 300 receives a serving broadcast packet, in an active mode, via a serving frame having a frame index of zero, and is then switched to a sleep mode. The receiver 300 can detect the timing information of the first target frame, ‘Δt1[0]={1, p0_start, p0_size}’, via the scheduling information of the serving broadcast packet, and the timing information of the second target frame ‘Δt1[1]={2, p1_start, p1_size}’. The receiver 300 can then be switched to an active mode at a start time point of the first target broadcast packet at the first target frame. In addition, the receiver 300 maintains an active mode during the time corresponding to the size of the first target broadcast packet and is then switched to a sleep mode.

The receiver 300 may not receive the first target broadcast packet in a reception failure area, such as an area where received signal strength is weak. The receiver 300 may be switched to an active mode at a start time point of the second target broadcast packet at the second target frame. The receiver 300 maintains an active mode during the time corresponding to the size of the second target broadcast packet and is then switched to a sleep mode.

As shown in FIG. 5b, the receiver 300 receives a serving broadcast packet, in an active mode, via a serving frame having a frame index of zero, and is then switched to a sleep mode. The receiver 300 can detect the timing information of the first target frame, ‘Δt2[0]={time0}’, via the scheduling information of the serving broadcast packet, and the timing information of the second target frame ‘Δt2[1]={time1}’. The receiver 300 can then be switched to an active mode at a start time point of the first target broadcast packet at the first target frame. The receiver 300 maintains an active mode until reaching the boundary of the first target frame and is then switched to a sleep mode.

The wireless broadcast communication system allows the transmitter 100 to generate scheduling information to detect broadcast packets via a plurality of frames and to transmit the scheduling information, thereby enhancing the use efficiency of the scheduling information. That is, although the receiver 300 fails to receive scheduling information via a particular frame, the receiver can detect a position of a broadcast packet using previously received scheduling information, thereby reducing both the time required to maintain an active mode and power consumption.

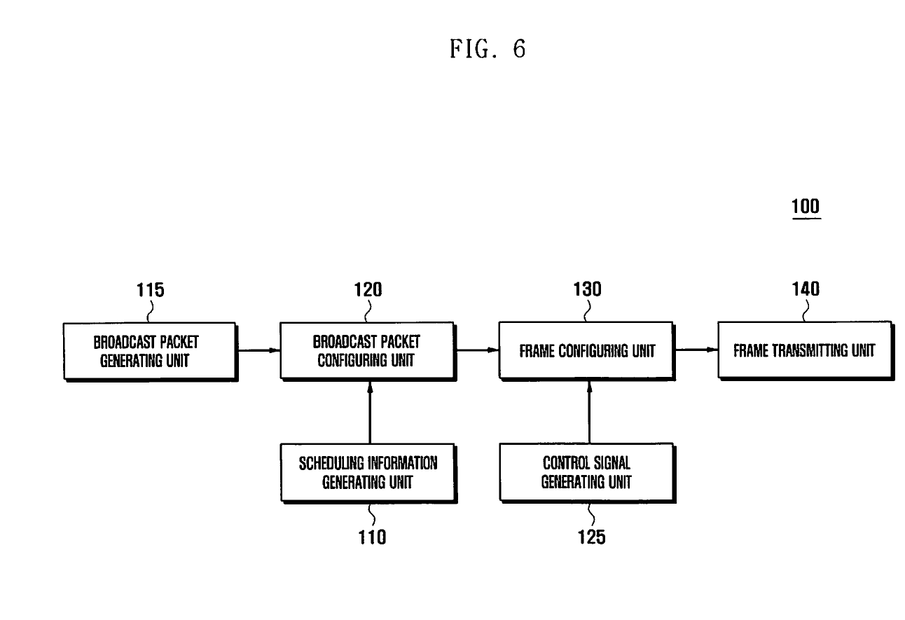

FIG. 6 illustrates a transmitter of a wireless broadcast communication system according to an embodiment of the present invention.

Referring to FIG. 6, the transmitter 100 includes a scheduling information generating unit 110, a broadcast packet generating unit 115, a broadcast packet configuring unit 120, a control signal generating unit 125, a frame configuring unit 130, and a frame transmitting unit 140.

The scheduling information generating unit 110 generates scheduling information according to broadcast channels. The broadcast packet generating unit 115 generates broadcast packets by broadcast channels, performs channel-coding for broadcast packets and generates at least one baseband frame with Forward Error Control (FEC). The broadcast packet configuring unit 120 multiplexes broadcast packets and scheduling information, and may insert the scheduling information, as inband signaling, into broadcast packets.

The broadcast packet configuring unit 120 may insert the scheduling information into a padding area of the baseband FEC frame of the front end. The control signal-generating unit 125 generates a control signal to be transmitted via each frame. The frame-configuring unit 130 configures frames based on broadcast packets and a control signal by multiplexing broadcast packets and a control signal at the time domain. The frame-transmitting unit 140 transmits the frames, and may transmit broadcast packets, via different broadcast channels, according to frames.

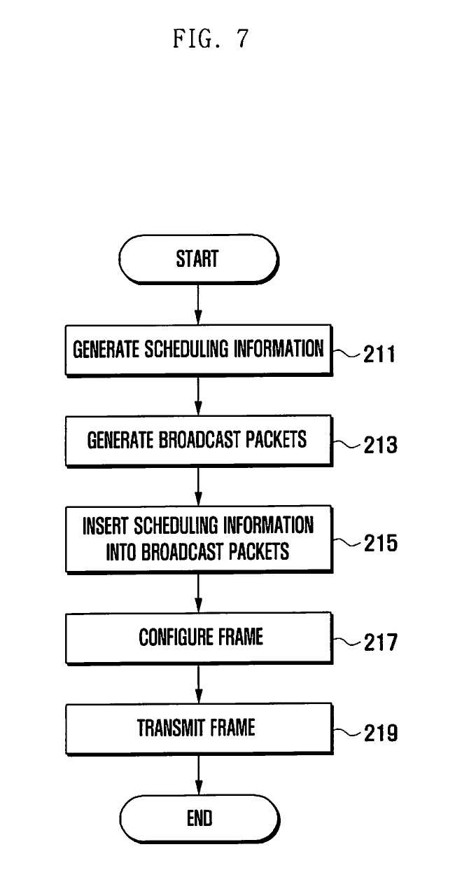

FIG. 7 illustrates a method for transmitting broadcast packets from a transmitter of a wireless broadcast communication system according to an embodiment of the present invention.

Referring to FIG. 7, the transmitter 100 generates scheduling information to be transmitted via a serving frame (211). The transmitter 100 generates scheduling information according to target broadcast packets to be transmitted after the serving frame. That is, the transmitter 100 generates scheduling information using timing information according to target broadcast packets at a plurality of target frames, i.e., the maximum number of target frames, Nmax, which can be scheduled.

The transmitter 100 generates broadcast packets (213). That is, the transmitter 100 generates serving broadcast packets to be transmitted via a serving frame. The transmitter 100 inserts scheduling information, as inband signaling, into the broadcast packets (215). The transmitter 100 may insert at least part of the scheduling information into the broadcast packets to correspond to the size of remaining portions except for substantial broadcast packets at the sub channel. The transmitter 100 configures a frame with a broadcast packet and a control signal (217), and transmits the frame (219).

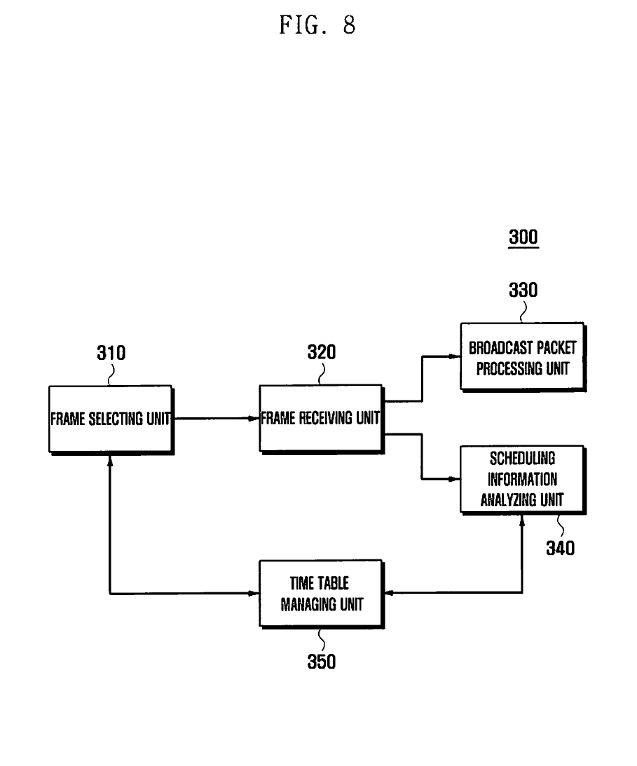

FIG. 8 illustrates a receiver of a wireless broadcast communication system according to an embodiment of the present invention.

Referring to FIG. 8, the receiver 300 includes a frame-selecting unit 310, a frame receiving unit 320, a broadcast packet processing unit 330, a scheduling information analyzing unit 340, and a time table managing unit 350.

The frame selecting unit 310 determines a frame transmitting a particular broadcast packet, and selects a frame according to the timing information regarding a previously stored broadcast packet. If previously stored timing information does not exist, the frame-selecting unit 310 can select each frame. The frame-receiving unit 320 receives a frame selected by the frame selecting unit 310, and may receive a particular broadcast packet and scheduling information regarding a corresponding broadcast packet via a corresponding frame, as well as a control signal of a corresponding frame.

The broadcast packet-processing unit 330 processes a corresponding broadcast packet. For example, the broadcast packet-processing unit 330 analyzes a broadcast packet and stores or outputs the analyzed broadcast packet. The scheduling information analyzing unit 340 analyzes corresponding scheduling information, and detects timing information regarding a corresponding broadcast packet. The time table managing unit 350 stores and manages corresponding timing information in a time table.

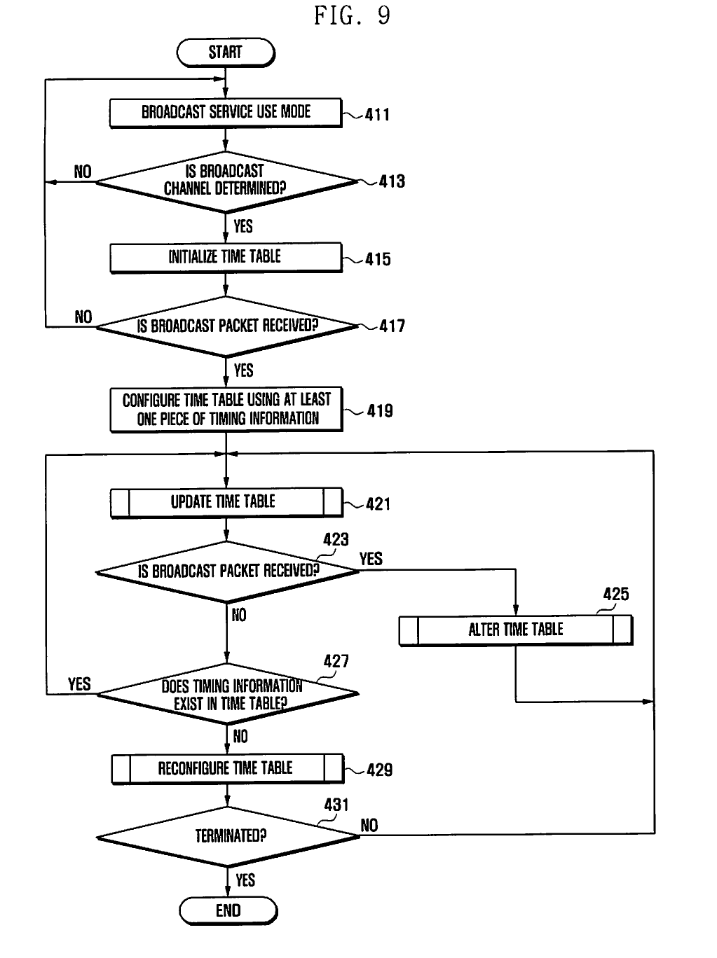

FIG. 9 illustrates a method for receiving broadcast packets from a transmitter of a wireless broadcast communication system according to an embodiment of the present invention.

Referring to FIG. 9, the receiver 300 executes a broadcast service use mode (411) by switching a power off state to a power on, or by switching a particular broadcast channel to another broadcast channel. When a broadcast channel is determined, the receiver 300 detects the broadcast channel (413), and initializes a time table (415). The receiver 300 stores timing information in a time table, as in the following Table 1.

TABLE 1

| Timing information | Proximity order |
|---|---|
| — | — |
| — | — |
| — | — |
| — | — |
| — | — |
| — | — |
| — | — |

When the receiver 300 receives a broadcast packet of a corresponding broadcast channel, it detects the received broadcast packet (417). The receiver 300 configures a time table using scheduling information regarding the broadcast packet (419). That is, the receiver 300 configures a time table, based on at least one piece of timing information in the scheduling information. The receiver 300 then adds the proximity order according to timing information to the time table. The proximity order is determined according to the degree of proximity with respect to serving frames according to target frames, i.e., with respect to serving broadcast packets according to target broadcast packets. For example, the closer a corresponding target frame to a serving frame, the lower the proximity order is determined. That is, the lowest order of proximity represents the highest priority order of proximity. The receiver 300 stores timing information in a time table as in the following Table 2.

TABLE 2

| Timing information | Proximity order |
|---|---|
| Δt[0] | 0 |
| Δt[1] | 1 |
| Δt[2] | 2 |
| Δt[3] | 3 |
| Δt[4] | 4 |
| — | — |
| — | — |
| — | — |

The receiver 300 updates the time table (421), switches its current mode to a sleep mode and detects a time point when it is switched to an active mode. That is, the receiver 300 detects a current frame according to time. The receiver 300 selects a frame via the timing information contained in the time table, deletes one piece of timing information in the time table and then alters the proximity order of the remaining timing information.

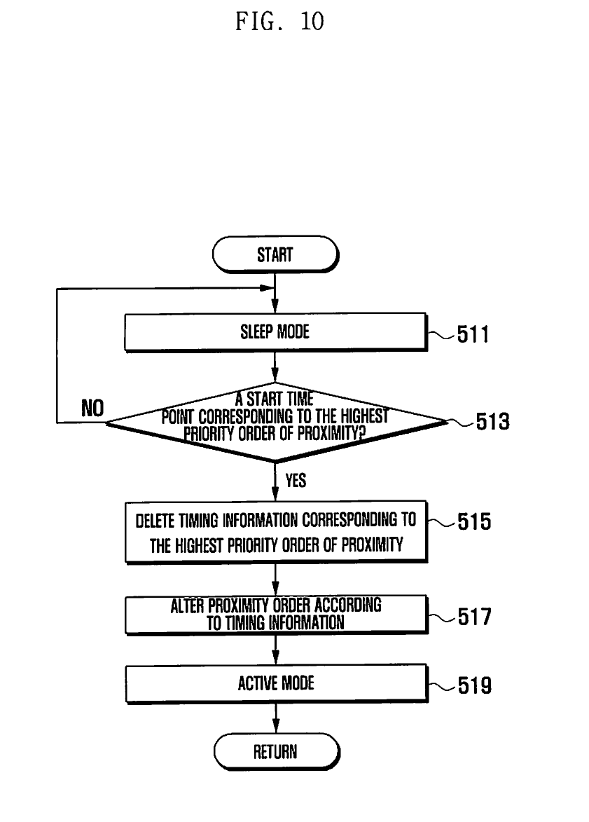

FIG. 10 illustrates a method of configuring a time table shown in FIG. 9.

Referring to FIG. 10, after storing the time table, the receiver 300 is switched to a sleep mode (511), in which the receiver 300 compares a current time with timing information corresponding to the proximity order of ‘zero’ in the time table. If it is a start time point, corresponding to the highest priority of proximity order, for example, timing information corresponding to the proximity order of zero, the receiver 300 detects the start time point (513), and deletes the timing information corresponding to the highest priority of proximity order from the time table (515). Next, the receiver 300 alters the proximity order of the timing information in the time table (517) by reducing the proximity order of the timing information by one. The receiver 300 is switched to an active mode to receive broadcast packets (519), and then returns to the procedure of FIG. 9. The receiver 300 stores timing information in a time table as in the following Table 3.

TABLE 3

| Timing information | Proximity order |
|---|---|
| Δt[1] | 0 |
| Δt[2] | 1 |
| Δt[3] | 2 |
| Δt[4] | 3 |
| — | — |
| — | — |
| — | — |

Referring back to FIG. 9, when the receiver 300 has received broadcast packets of a corresponding broadcast channel (423), it alters the time table using scheduling information regarding the broadcast packet (425). The receiver 300 can receive the broadcast packet by maintaining an active mode during the time corresponding to the size of the broadcast packet. Alternatively, the receiver 300 can receive the broadcast packet by maintaining an active mode until the boundary of the current frame is reached. To this end, the receiver 300 is preferably set such that the closer the generation time point of scheduling information to the current time point, the more precise the scheduling information. The receiver 300 may alter or maintain the stored time table. After that, the receiver 300 returns and proceeds with step 421.

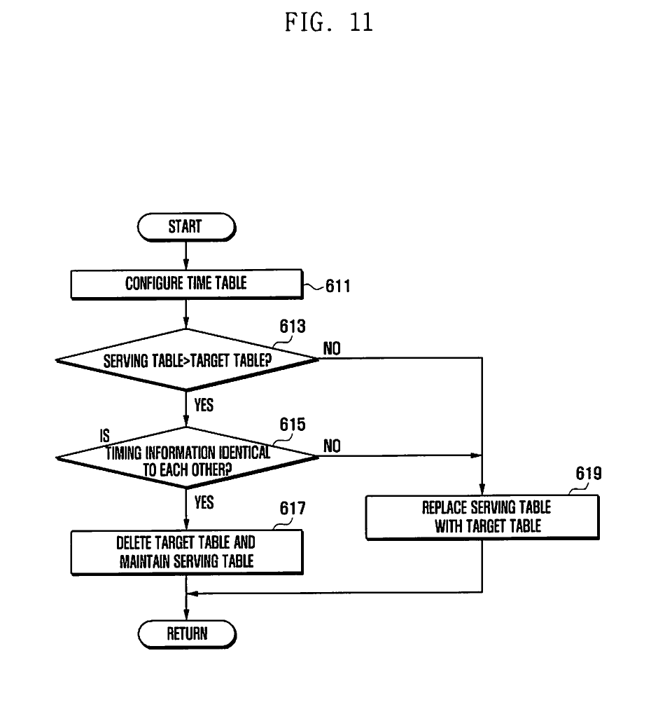

FIG. 11 illustrates a method of altering a time table shown in FIG. 9.

Referring to FIG. 11, when the receiver 300 receives a broadcast packet, it configures a time table using scheduling information regarding the broadcast packet (611). The receiver 300 configures a stored time table, i.e., a serving table, and an additional time table, i.e., a target table. The receiver 300 stores timing information in a time table as in the following Table 4.

TABLE 4

| Timing information | Proximity order |
|---|---|
| Δt′[1] | 0 |
| Δt′[2] | 1 |
| Δt′[3] | 2 |
| Δt′[4] | 3 |
| — | — |
| — | — |

The receiver 300 then compares the number of pieces of timing information in the serving table with that in the target table (613) by determining whether the number of timing information pieces in the serving table is greater than the number of timing information pieces in the target table. If the receiver 300 ascertains that the number of timing information pieces in the serving table is greater than of the number of timing information pieces in the target table at step 613, it further compares the timing information in the serving table with that in the target table (615).

That is, the receiver 300 determines whether the timing information in the serving table is identical to that in the target table at step 615. For example, if the number of pieces of timing information in the serving table is ten and the number of pieces of timing information in the target table is five, the receiver 300 compares the timing information of the serving table with that of the target table, according to their proximity order. That is, the receiver 300 matches five pieces of timing information, corresponding to the proximity order 0˜4, between the serving table and the target table, respectively. If the receiver 300 ascertains that the timing information in the serving table is identical to that in the target table at step 615, it deletes the target table and maintains the serving table (617). The receiver 300 then returns to and proceeds with the procedure outlined in FIG. 9.

If the receiver 300 ascertains that the number of pieces of the timing information in the serving table is equal to or less than that of the timing information in the target table at step 613, it replaces the serving table with the target table (619). That is, the receiver 300 deletes the serving table and stores the target table, and returns to and proceeds with the procedure outlined in FIG. 9.

Meanwhile, if the receiver 300 ascertains that the timing information in the serving table differs from that in the target table at step 615, it replaces the serving table with the target table at step 619. That is, the receiver 300 deletes the serving table and stores the target table, and returns to and proceeds with the procedure outlined in FIG. 9.

Referring back to FIG. 9, if the receiver 300 fails to receive broadcast packets at step 423, it determines whether timing information exists in the time table (427). When the receiver 300 ascertains that timing information exists in the time table at step 427, it returns to and proceeds with step 421. Although the receiver 300 fails to receive broadcast packets at step 423, it can attempt to receive the broadcast packets by repeating steps 421 to 427 according to the number of pieces of timing information contained in the time table. However, when the receiver 300 ascertains that timing information does not exist in the time table at step 427, it reconfigures the time table (429).

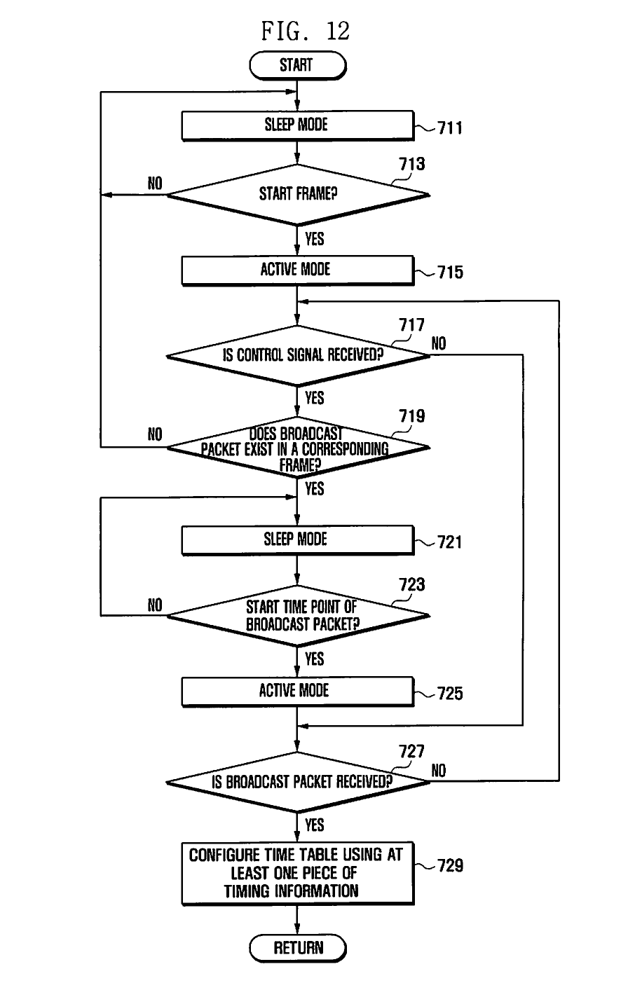

FIG. 12 illustrates a method of reconfiguring a time table shown in FIG. 9.

Referring to FIG. 12, if the receiver 300 ascertains that timing information does not exist in the time table at step 427 shown in FIG. 9, it is switched to a sleep mode (711). The receiver 300 maintains the sleep mode until the boundary of the current frame is reached. After that, if the start position of the next frame occurs at the boundary of the current frame, the receiver 300 detects the start position (713), and is switched to an active mode (715).

The receiver 300 determines whether to receive a control signal in an active mode at step (717), and then analyzes the control signal and determines whether a broadcast packet of a corresponding broadcast channel exists in a corresponding frame (719). If the receiver 300 ascertains that a broadcast packet of a corresponding broadcast channel does not exist in a corresponding frame at step 719, it repeats steps 711 to 719.

That is, the receiver 300 receives a control signal of each frame until a broadcast packet of a corresponding broadcast channel exists. If the receiver 300 ascertains that a broadcast packet of a corresponding broadcast channel exists in a corresponding frame at step 719, it is switched to a sleep mode (721). The receiver 300 can detect a start time point of a corresponding broadcast packet. When a start time point of a corresponding broadcast packet occurs, the receiver 300 detects it (723), and then is switched to an active mode (725).

When the receiver 300 has received a corresponding broadcast packet in the active mode at step 725, it detects it (727), and configures a time table using scheduling information regarding the broadcast packet (729). That is, the receiver 300 configures a time table using at least one piece of timing information in the scheduling information, and returns to and proceeds with the procedure outlined in FIG. 9.

If the receiver 300 fails to receive a control signal at step 717 or a broadcast packet at step 727, it repeats steps 717 to 727. That is, the receiver 300 receives each frame until it receives a broadcast packet of a corresponding broadcast channel.

Referring back to FIG. 9, after having reconfigured a time table at step 429, the receiver 300 determines whether to terminate a broadcast service user mode (431). If the receiver 300 ascertains that a broadcast service user mode does not need to be terminated at step 431, it repeats steps 421 to 431. Otherwise, the receiver 300 terminates a broadcast service user mode.

Although embodiments of the present invention have involved the timing information including an interval between a serving frame and a target frame or between target frames, a start time point of a target broadcast packet in a target frame, and the size of a target broadcast packet, it should be understood that the present invention is not limited to the embodiment. For example, the timing information does not have to include the size of a target broadcast packet. That is, when the transmitter receives timing information, comprised of an interval between a serving frame and a target frame or between target frames, and a start time point of a target broadcast packet in a target frame, the receiver can be switched to an active mode at the start time point of the target broadcast packet. In addition, the receiver maintains the active mode until the boundary of the target frame is reached, and then is switched to a sleep mode.

In addition, the timing information herein may further include the size of a target broadcast packet. That is, when the transmitter receives timing information, comprised of a start time point difference between a serving broadcast packet and a target broadcast packet or between target broadcast packets, and the size of a target broadcast packet, the receiver can be switched to an active mode at the start time point of the target broadcast packet. In addition, the receiver maintains the active mode during the time corresponding to the size of the target broadcast packet and then is switched to a sleep mode.

Furthermore, the transmitter herein can transmit scheduling information via the control signal, as the scheduling information is inserted into a broadcast packet. For example, if the receiver fails to receive broadcast packets and timing information does not exist in the time table, the receiver can receive a control signal of a particular frame and configure a time table of a corresponding broadcast packet using scheduling information of the control signal. In that case, the receiver does not need to receive a control signal of each frame until it receives a corresponding broadcast packet.

As described above, the wireless broadcast communication system and broadcast service method use scheduling information in order to detect broadcast packets at a plurality of frames, thereby enhancing the use efficiency of the scheduling information. That is, although the receiver fails to receive scheduling information at a particular frame, it can detect the position of a broadcast packet using previously received scheduling information. Therefore, the receiver can reduce time to maintain an active mode, thereby reducing power consumption.

Although embodiments of the present invention have been described in detail hereinabove, it should be understood that many variations and modifications of the basic inventive concept herein described, which may be apparent to those skilled in the art, will still fall within the spirit and scope of the embodiments of the present invention as defined in the appended claims.

What is claimed is:

1. A broadcast service method of a transmitter in a wireless communication system, the method comprising:
inserting scheduling information, as inband signaling, into a serving broadcast packet, and transmitting the serving broadcast packet via one of a plurality of frames, wherein the scheduling information includes timing information regarding next target broadcast packets; and
transmitting the target broadcast packets according to the timing information.

2. The method of claim 1, wherein the timing information comprises:
an interval between a serving frame transmitting the serving broadcast packet, and a target frame transmitting one of the target broadcast packets, or between the target frame and another target frame transmitting another one of the target broadcast packets; and
a start time point of the target broadcast packet in the target frame.

3. The method of claim 1, wherein the timing information comprises:
a start time point difference between the serving broadcast packet and the target broadcast packet or between the target broadcast packets.

4. The method of claim 2, wherein the timing information further comprises a size of the target broadcast packet.

5. The method of claim 3, wherein the timing information further comprises a size of the target broadcast packet.

6. A broadcast service method of a receiver in a wireless communication system, the method comprising:
receiving scheduling information via a serving broadcast packet from one of a plurality of frames, wherein the scheduling information, as inband signaling, is inserted into the serving broadcast packet, and includes timing information regarding next target broadcast packets; and
receiving the target broadcast packets according to the timing information.

7. The method of claim 6, wherein:
the timing information includes a start time point of the target broadcast packet; and
receiving the target broadcast packets includes switching a sleep mode to an active mode in order to receive the target broadcast packets when a start time point of the target broadcast packet occurs.

8. The method of claim 7, wherein:
the timing information further includes a size of the target broadcast packet, and receiving the target broadcast packets further includes
switching the active mode to the sleep mode when a time difference corresponding to the size of the target broadcast packet has elapsed.

9. The method of claim 7, wherein receiving the target broadcast packets further comprises:
switching the active mode to the sleep mode when a boundary of a target frame transmitting the target broadcast packet has been reached.

10. The method of claim 6, further comprising:
analyzing the scheduling information and detecting the timing information; and
adding the proximity order and the serving broadcast packet by the target broadcast packets to the timing information and configuring a time table in order to refer to the reception of the target broadcast packets.

11. A transmitter of a wireless communication system, comprising:
a broadcast packet configuring unit for inserting scheduling information, as inband signaling, into a serving broadcast packet, wherein the scheduling information includes timing information regarding next target broadcast packets; and
a frame transmitting unit for transmitting the serving broadcast packet via one of a plurality of frames, and transmitting target broadcast packets according to the timing information.

12. The transmitter of claim 11, wherein the timing information comprises:
an interval between a serving frame transmitting the serving broadcast packet, and a target frame transmitting one of the target broadcast packets, or between the target frame and another target frame transmitting another one of the target broadcast packets; and
a start time point of the target broadcast packet in the target frame.

13. The transmitter of claim 11, wherein the timing information comprises:
a start time point difference between the serving broadcast packet and the target broadcast packet or between the target broadcast packets.

14. The transmitter of claim 12, wherein the timing information further comprises a size of the target broadcast packet.

15. The transmitter of claim 13, wherein the timing information further comprises a size of the target broadcast packet.

16. A receiver in a wireless communication system, comprising:
a frame receiving unit for receiving a serving broadcast packet via one of a plurality of frames, and next target broadcast packets;
a scheduling information analyzing unit for analyzing scheduling information including timing information of the target broadcast packets when the serving broadcast packet is received, wherein the scheduling information, as inband signaling, is inserted into the serving broadcast packet; and
a frame selecting unit for performing a control operation to receive the target broadcast packets according to the timing information.

17. The receiver of claim 16, wherein:
the timing information comprises a start time point of the target broadcast packet; and
the frame selecting unit switches a sleep mode to an active mode in order to receive the target broadcast packets when a start time point of the target broadcast packet is reached.

18. The receiver of claim 17, wherein:
the timing information further comprises a size of the target broadcast packet; and
the frame selecting unit switches the active mode to the sleep mode when a time difference corresponding to the size of the target broadcast packet has elapsed.

19. The receiver of claim 17, wherein the frame selecting unit switches the active mode to the sleep mode when a boundary of a target frame transmitting the target broadcast packet is reached.

20. The receiver of claim 16, further comprising:
a time table managing unit for adding the proximity order and the serving broadcast packet by the target broadcast packets to the timing information and configuring a time table in order to refer to the reception of the target broadcast packets.
